(19) United States
(12) Patent Application Publication
(10) Pub. No.: US 2026/0255263 A1
(43) Pub. Date: Aug. 27, 2026

(54) INFORMATION PROCESSING APPARATUS, INFORMATION PROCESSING METHOD, AND COMPUTER READABLE MEDIUM

(71) Applicant: NEC Corporation, Minato-ku, Tokyo (JP)

(72) Inventors: Masayuki TAKEKAWA, Tokyo (JP); Kosei KOBAYASHI, Tokyo (JP); Masaaki TAKEUCHI, Tokyo (JP); Nobuyuki TOZAWA, Tokyo (JP); Kazuki OGATA, Tokyo (JP)

(73) Assignee: NEC Corporation, Minato-ku, Tokyo (JP)

(21) Appl. No.: 18/726,438

(22) PCT Filed: Jan. 12, 2022
(86) PCT No.: PCT/JP2022/000746

§ 371 Date: Jul. 3, 2024

(51) Int. Cl. H04W 48/18; G06V 20/59; H04W 4/44

(52) U.S. Cl. CPC H04W 48/18; G06V 20/59; H04W 4/44

(57) ABSTRACT

An information processing apparatus (10) includes: acquisition means (11) for acquiring information indicating a state of at least one of a person riding in a mobile body and an object mounted on the mobile body; and specification means (12) for specifying radio communication means used for communication between the mobile body and an external apparatus based on the information acquired by the acquisition means.

### TECHNICAL FIELD

The present disclosure relates to an information processing apparatus, an information processing method, and a non-transitory computer readable medium storing a program.

### BACKGROUND ART

Patent Literature 1 discloses that the priority and the quality of the captured image in the imaging direction where the needs of a data center are high are changed to be higher in accordance with vehicle situations including “straight”, “right turn”, “left turn”, “reverse”, “boarding stop”, and “occupant anomalies” such as a driver's inability to drive, and the changed data is transmitted to the data center. Thus, the data required by the center can be preferentially transmitted in accordance with the vehicle situations.

### CITATION LIST

### Patent Literature

Patent Literature 1: Japanese Unexamined Patent Application Publication No. 2020-003934

### SUMMARY OF INVENTION

### Technical Problem

However, by the technology disclosed in Patent Literature 1, for example, it may be possible that a sufficient amount of data required by the center cannot be transmitted.

In view of the above-described problem, an object of the present disclosure is to provide an information processing apparatus, an information processing method, and a non-transitory computer readable medium storing a program by which it is possible to appropriately perform communication in a mobile body such as a vehicle.

### Solution to Problem

In a first example aspect according to the present disclosure, an information processing apparatus includes: acquisition means for acquiring information indicating a state of at least one of a person riding in a mobile body and an object mounted on the mobile body; and specification means for specifying radio communication means used for communication between the mobile body and an external apparatus based on the information acquired by the acquisition means.

Further, in a second example aspect according to the present disclosure, an information processing method including: acquiring information indicating a state of at least one of a person riding in a mobile body and an object mounted on the mobile body; and specifying radio communication means used for communication between the mobile body and an external apparatus based on the acquired information.

Further, in a third example aspect according to the present disclosure, a non-transitory computer readable medium storing a program for causing a computer to: acquire information indicating a state of at least one of a person riding in a mobile body and an object mounted on the mobile body; and specify radio communication means used for communication between the mobile body and an external apparatus based on the acquired information.

### Advantageous Effects of Invention

According to one example aspect of the present disclosure, it is possible to appropriately perform communication in a mobile body such as a vehicle.

### BRIEF DESCRIPTION OF DRAWINGS

FIG. 1 is a diagram showing an example of a configuration of an information processing apparatus according to an example embodiment;

FIG. 2 is a diagram showing an example of a configuration of an information processing system according to an example embodiment;

FIG. 3 is a diagram showing an example of a hardware configuration of an information processing apparatus according to an example embodiment;

FIG. 4 is a diagram showing an example of a configuration of an information processing apparatus according to an example embodiment;

FIG. 5 is a sequence diagram showing an example of processes performed by an information processing system according to an example embodiment; and

FIG. 6 is a diagram showing an example of information recorded in a radio DB according to an example embodiment.

### EXAMPLE EMBODIMENT

The principle of the present disclosure will be described with reference to some illustrative example embodiments. It should be understood that these example embodiments are described for illustrative purposes only and will assist those skilled in the art in understanding and implementing the present disclosure without suggesting any limitations with regard to the scope of the present disclosure. The disclosure described herein may be implemented in a variety of ways other than those described below.

In the following description and claims, unless otherwise defined, the meanings of all technical and scientific terms used herein are the same as those generally understood by those skilled in the art to which the present disclosure pertains. Example embodiments of the present invention will be described hereinafter with reference to the drawings.

### First Example Embodiment

### Configuration

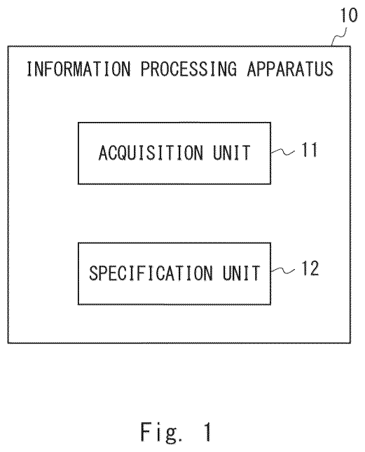

A configuration of an information processing apparatus 10 according to an example embodiment will be described with reference to FIG. 1. FIG. 1 is a diagram showing an example of a configuration of the information processing apparatus 10 according to the example embodiment. The information processing apparatus 10 includes an acquisition unit 11 and a specification unit 12. These units may be implemented by one or more programs installed in the information processing apparatus 10 and hardware of the information processing apparatus 10 such as a processor 101 and a memory 102 operating in cooperation with each other.

The acquisition unit 11 acquires information (e.g., an image including at least one of a still image and a moving image) indicating a state of at least one of a person riding in a mobile body and an object mounted on the mobile body. The specification unit 12 specifies radio communication means used for communication between the mobile body and an external apparatus based on the information acquired by the acquisition unit 11.

### Second Example Embodiment

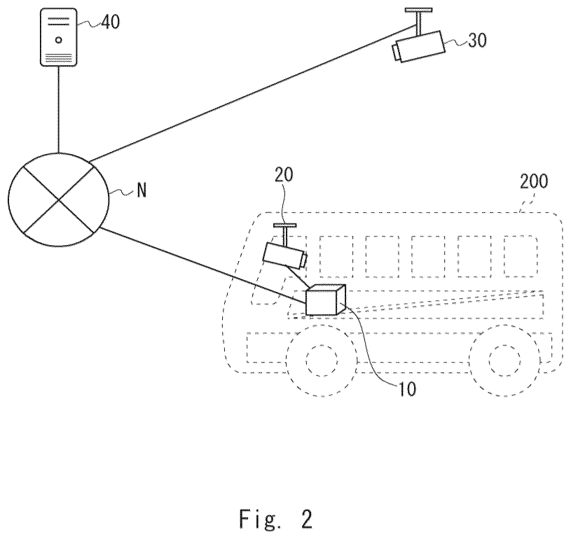

Next, a configuration of an information processing system 1 according to an example embodiment will be described with reference to FIG. 2.

### System Configuration

FIG. 2 is a diagram showing an example of the configuration of the information processing system 1 according to the example embodiment. In the example shown in FIG. 2, the information processing system 1 includes the information processing apparatus 10, an image capturing apparatus 20, an image capturing apparatus 30, and a server 40. Note that the number of the information processing apparatuses 10, the number of the image capturing apparatuses 20, the number of the image capturing apparatuses 30, and the number of the servers 40 are not limited to those shown in the example of FIG. 1.

The information processing apparatus 10, the image capturing apparatus 20, the image capturing apparatus 30, and the server 40 are connected to each other through a network N such as the Internet, a wireless Local Area Network (LAN), a mobile phone network, a cable, and a bus so that they can communicate with each other. The network N described in the present disclosure may include, for example, the fifth generation mobile communication system (5G, NR: New Radio), the fourth generation mobile communication system (4G), and the third generation mobile communication system (3G). Note that the 4G may include, for example, Long Term Evolution (LTE) Advanced, WiMAX2, and LTE. Further, the network N described in the present disclosure may include, for example, the sixth generation mobile communications system (6G, Beyond 5G). Further, the radio communication described in the present disclosure may be performed in accordance with any generation of a known radio communication protocol or a wireless communication protocol developed in the future.

The information processing apparatus 10, for example, may be mounted on a mobile body 200 such as a vehicle, an autonomous traveling robot, and a flying car (Electric Vertical Take-Off and Landing aircraft (eVTOL), Urban Air Mobility (UAM)). Note that examples of a vehicle according to the present disclosure include, but are not limited to, an automobile, a motorcycle, a motor-assisted bicycle, and a bicycle.

The image capturing apparatus 20 may, for example, be mounted on the mobile body 200, and provided in the mobile body (e.g., in a vehicle) or in a position where it can capture an image of a parcel carrier. Note that the information processing apparatus 10 and the image capturing apparatus 20 may be configured as an integrated apparatus. In this case, the information processing apparatus 10 may be, for example, a smartphone or a tablet.

The image capturing apparatus 30 is, for example, an image capturing apparatus (a camera) provided outside the mobile body 200 and installed so that it can capture an image of a route (e.g., a road) along which the mobile body 200 moves. In this case, the image capturing apparatus 30 may be, for example, attached to a pole (a signal pole) to which a traffic signal is attached, a pole to which a road sign or the like is attached, a street light, a gate at the entrance of a highway, and a utility pole. Further, the image capturing apparatus 30 may be, for example, provided in a facility such as a store.

The server 40 is an apparatus that performs at least one of monitoring of the mobile body 200 and control of the mobile body 200. The server 40 may, for example, perform monitoring or the like of the mobile body 200 based on images captured by at least one of the image capturing apparatus 20 and the image capturing apparatus 30.

### Hardware Configuration

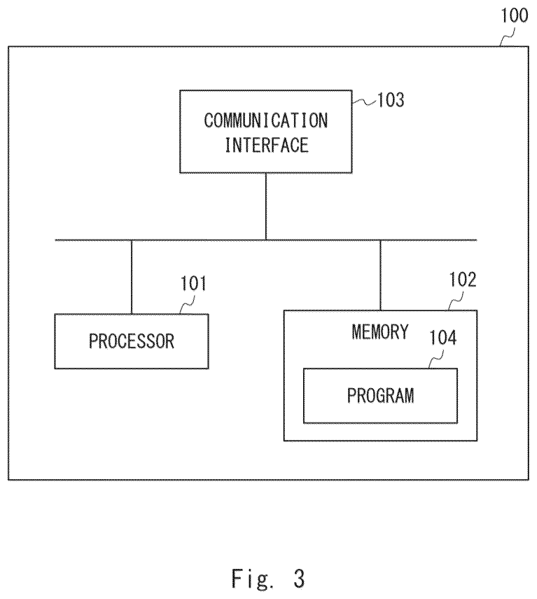

FIG. 3 is a diagram showing an example of a hardware configuration of the information processing apparatus 10 according to the example embodiment. In the example shown in FIG. 3, the information processing apparatus 10 (a computer 100) includes the processor 101, the memory 102, and a communication interface 103. These components may be connected to each other by a bus or the like. The memory 102 stores at least a part of a program 104. The communication interface 103 includes an interface required for communication with other network elements.

When the program 104 is executed in cooperation with the processor 101, the memory 102 and the like, the computer 100 performs at least some of the processes of the example embodiments of the present disclosure. The memory 102 may be of any type suitable for a local technical network. The memory 102 may, as a non-limiting example, be a non-transitory computer readable storage medium. Further, the memory 102 may be implemented using any suitable data storage technology, such as a semiconductor-based memory device, a magnetic memory device and system, an optical memory device and system, a fixed memory, and a removable memory. Although only one memory 102 is shown in the computer 100, the computer 100 may include several memory modules that are physically different from each other. The processor 101 may be of any type. The processor 101 may include one or more of a general-purpose computer, a dedicated computer, a microprocessor, a Digital Signal Processor (DSP), and a processor based on a multi-core processor architecture as a non-limiting example. The computer 100 may include a plurality of processors, such as an application-specific integrated circuit chip that is temporally dependent on a clock that synchronizes the main processor.

The example embodiments of the present disclosure may be implemented in hardware or a dedicated circuit, software, logic, or any combination thereof. Some example aspects may be implemented in hardware, while other example aspects may be implemented in firmware or software that may be executed by a controller, a microprocessor, or other computing devices.

The present disclosure also provides at least one computer program product that is tangibly stored in a non-transitory computer readable storage medium. The computer program product includes computer executable instructions, such as instructions included in program modules, and is executed on a device on a target real or virtual processor to perform the processes or the method according to the present disclosure. The program modules include routines, programs, libraries, objects, classes, components, data structures, and the like that perform specific tasks or implement specific abstract data types. The functions of the program modules may be combined or divided among the program modules as desired in various example embodiments. Machine executable instructions for the program modules can be executed in a local or a distributed device. In a distributed device, program modules can be located in both local and remote storage media.

Program codes for performing the method according to the present disclosure may be written in any combination of one or more programming languages. These program codes are provided to a processor or a controller of a general-purpose computer, a dedicated computer, or other programmable data processing apparatuses. When the program codes are executed by the processor or the controller, functions/operations in the flowchart and/or a block diagram to be implemented are executed. The program codes are executed entirely on a machine, partly on a machine, as a stand-alone software package, partly on a machine, partly on a remote machine, or entirely on a remote machine or a server.

The program can be stored and provided to a computer using any type of non-transitory computer readable media. Non-transitory computer readable media include any type of tangible storage media. Examples of non-transitory computer readable media include magnetic storage media, optical magnetic storage media, optical disc media, semiconductor memories, and the like. Magnetic storage media include, for example, flexible disks, magnetic tapes, hard disk drives, and the like. Optical magnetic storage media include, for example, magneto-optical disks and the like. Optical disk media include, for example, a Blu-ray disc, a Compact Disc (CD)-Read Only Memory (ROM), a CD-Recordable (R), a CD-ReWritable (RW), and the like. Semiconductor memories include, for example, a mask ROM, a Programmable ROM (PROM), an Erasable PROM (EPROM), a flash ROM, a random access memory (RAM), and the like. The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

### Configuration

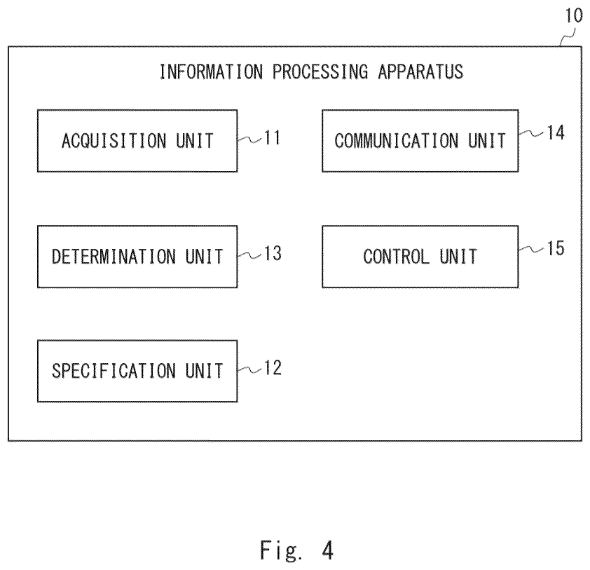

A configuration of the information processing apparatus 10 according to the example embodiment will be described with reference to FIG. 4. FIG. 4 is a diagram showing an example of the configuration of the information processing apparatus 10 according to the example embodiment. In the example of FIG. 4, the information processing apparatus 10 further includes, in addition to the components shown in the example of FIG. 1, a determination unit 13, a communication unit 14, and a control unit 15. These units may be implemented by one or more programs installed in the information processing apparatus 10 and hardware of the information processing apparatus 10 such as the processor 101 and the memory 102 operating in cooperation with each other.

The determination unit 13 determines the state of at least one of a person riding in the mobile body 200 and an object mounted on the mobile body 200 based on the image acquired by the acquisition unit 11. The communication unit 14 communicates with the server 40 using the radio communication means specified by the specification unit 12. The control unit 15 controls each of the functions (e.g., the functions related to braking, propulsion, driving, steering, and the like) of the mobile body 200 based on control information received from the server 40.

### Processing

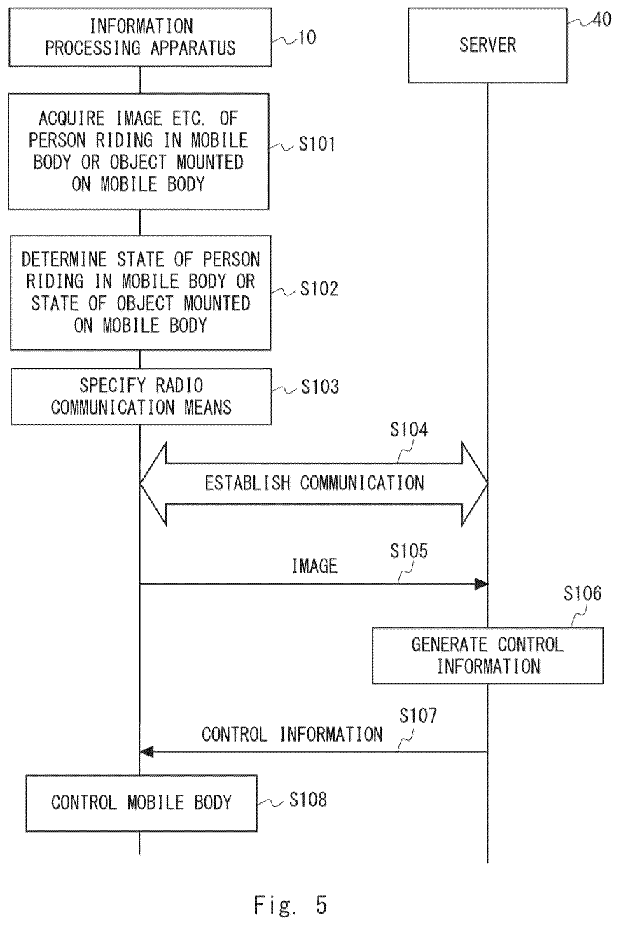

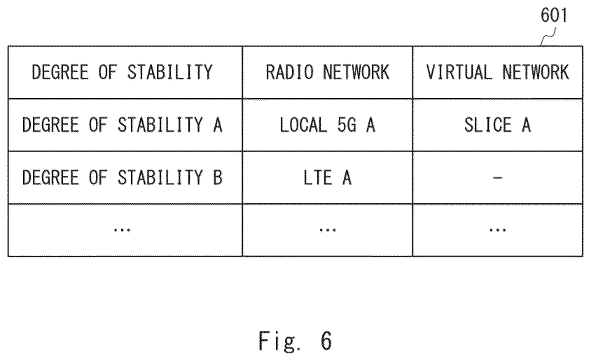

An example of processes performed by the information processing system 1 according to the example embodiment will be described with reference to FIGS. 5 and 6. FIG. 5 is a sequence diagram showing the example of processes performed by the information processing system 1 according to the example embodiment. FIG. 6 is a diagram showing an example of information recorded in a radio DB 601 according to the example embodiment. Note that the following processes may be performed at a specific timing, for example, periodically.

In Step S101, the acquisition unit 11 of the information processing apparatus 10 acquires an image (at least one of a moving image and a still image) of at least one of a person riding in the mobile body 200 and an object mounted on the mobile body 200 captured by at least one of the image capturing apparatus 20 and the image capturing apparatus 30. Note that the aforementioned image is an example of “information indicating a state of at least one of a person riding in a mobile body and an object mounted on the mobile body”.

Next, the determination unit 13 of the information processing apparatus 10 determines (estimates, infers) the state of at least one of the person riding in the mobile body 200 and the object mounted on the mobile body 200 based on the image acquired by the acquisition unit 11 (Step S102). Here, the determination unit 13 may determine the state using, for example, Artificial Intelligence (AI) by deep learning or the like.

Note that the aforementioned state may include, for example, the number of persons riding in the mobile body 200, whether or not the person is standing, whether or not the person is holding on to equipment (e.g., a strap, a handrail) provided in the mobile body 200, the age of the person, and the gender of the person. Further, the aforementioned state may include, for example, whether or not the person is using a wheelchair and whether or not the person is using a mobility assistive device (e.g., crutches) that transfers the weight from the legs to the upper body.

Further, the aforementioned state may include, for example, the number of objects (e.g., loads) mounted on the mobile body 200, the weight of the object, and the degree of shaking of the object. Note that the degree of shaking of the object may be, for example, an index indicating the magnitude of wobbling of the object. The determination unit 13 may, for example, determine that a value of the degree of shaking of the object becomes higher as the frequency of wobbling of the object increases and as the amount of movement of the object increases.

Next, the specification unit 12 of the information processing apparatus 10 specifies (determines, selects) radio communication means to be used for communication with the server 40 based on the state determined by the determination unit 13 (Step S103). Thus, for example, the radio communication means to be used can be classified in accordance with the degree of stability of the mobile body 200 or the like. Therefore, for example, a plurality of mobile bodies use the same radio communication means (e.g., a local 5G), whereby it is possible to reduce the deterioration of the communication quality caused by a radio network congestion of the radio communication means.

Note that, for example, the specification unit 12 may refer to the radio DB 601 shown in FIG. 6 and then specify at least one of a radio network and a virtual network (e.g., a slice) used for radio communication between the apparatus (e.g., the information processing apparatus 10) on the mobile body 200 side and the server 40.

In the example shown in FIG. 6, a radio network and a virtual network are associated with the degree of stability of the mobile body 200 and stored (set, registered) in the radio DB 601. Note that the radio DB 601 may be stored (set, registered) in advance in a storage apparatus inside or outside the information processing apparatus 10.

The degree of stability of the mobile body 200 is, for example, an index indicating the degree of stability of the mobile body 200 when it moves with regard to at least one of a person riding in the mobile body and an object mounted on the mobile body. The specification unit 12 may, for example, calculate a value of the degree of stability of the mobile body 200 based on the state of at least one of a person riding in the mobile body 200 and an object mounted on the mobile body 200 determined by the determination unit 13. In this case, the specification unit 12 may, for example, calculate a value of the degree of stability of the mobile body 200 using the number of persons riding in the mobile body 200, an attribute of the person, or a posture of the person, or a device used by the person, or any combination thereof. Note that the attribute of the person may include the age, the gender, the body size, and whether or not the person is a pregnant woman. Further, the posture of the person may include whether or not the person is standing, whether or not the person is holding on to equipment (e. g., a strap), and the like. The device used by the person may include a wheelchair, a mobility assistive device (e.g., crutches), and the like.

In this case, for example, the specification unit 12 may determine that a value of the degree of stability of the mobile body 200 becomes lower as the number of persons riding in the mobile body 200 increases. Further, for example, the specification unit 12 may determine that a value of the degree of stability of the mobile body 200 becomes lower as the number of persons riding in the mobile body 200 while standing (not sitting in the seat) increases. Further, for example, the specification unit 12 may determine that a value of the degree of stability of the mobile body 200 becomes lower as the number of persons riding in the mobile body 200 while standing (not sitting in the seat) and not holding on to equipment (e.g., a strap, a handrail) provided in the mobile body 200 increases. Further, for example, the specification unit 12 may determine that, when the age of a person riding in the mobile body 200 while standing and not holding on to equipment provided in the mobile body 200 is equal to or greater than a first threshold (e.g., 70 years old), a value of the degree of stability of the mobile body 200 becomes lower as the difference between the age of the person and the first threshold becomes larger. Thus, for example, when an elderly person is standing and not holding on to a strap or the like, a value of the degree of stability of the mobile body 200 can be determined to be low.

Further, for example, the specification unit 12 may determine that, when the age of a person riding in the mobile body 200 while standing and not holding on to equipment provided in the mobile body 200 is less than or equal to a second threshold (e.g., 6 years old), a value of the degree of stability of the mobile body 200 becomes lower as the absolute value of the difference between the age of the person and the second threshold becomes larger. Thus, for example, when an infant or the like is standing and not holding on to a strap or the like, a value of the degree of stability of the mobile body 200 can be determined to be low.

Further, for example, the specification unit 12 may determine that a value of the degree of stability of the mobile body 200 becomes lower as the number of pregnant women riding in the mobile body 200 while standing and not holding on to equipment provided in the mobile body 200 increases. Further, for example, the specification unit 12 may determine that a value of the degree of stability of the mobile body 200 becomes lower as the number of persons riding in the mobile body 200 and using a mobility assistive device such as crutches while standing and not holding on to equipment provided in the mobile body 200 increases. Further, for example, the specification unit 12 may determine that a value of the degree of stability of the mobile body 200 becomes lower as the number of persons riding in the mobile body 200 and using a wheelchair increases.

Further, the specification unit 12 may calculate a value of the degree of stability of the mobile body 200 by using the number of objects mounted on the mobile body 200, a weight of the object, a size of the object, a shape of the object, a value of the object (the object is precious or not), or the degree of shaking of the object, or any combination thereof. In this case, the specification unit 12 may, for example, determine that a value of the degree of stability of the mobile body 200 becomes lower as the number of objects (e.g., loads) mounted on the mobile body 200 increases. Further, the specification unit 12 may, for example, determine that a value of the degree of stability of the mobile body 200 becomes lower as the weight of the object mounted on the mobile body 200 becomes heavier. Further, the specification unit 12 may, for example, determine that a value of the degree of stability of the mobile body 200 becomes lower as the degree of shaking of the object mounted on the mobile body 200 becomes higher. Note that when a person is riding in the mobile body 200 and an object is mounted on the mobile body 200, the specification unit 12 may calculate the degree of stability of the mobile body 200 based on both the state of the person and the state of the object.

The radio network shown in FIG. 6 is a radio network of a network used for communication between the mobile body 200 and the server 40. The radio network may include, for example, a radio network using a local 5G or a Radio Access Technology (RAT) such as LTE. The virtual network shown in FIG. 6 may be, for example, a slice in a radio network. Thus, for example, radio communication means having an appropriate communication quality in accordance with the state of a passenger or the like can be assigned to each mobile body 200.

Next, the communication unit 14 of the information processing apparatus 10 establishes communication between it and the server 40 using the radio communication means specified by the specification unit 12 (Step S104). Next, the communication unit 14 of the information processing apparatus 10 transmits, for example, information such as an image captured by the image capturing apparatus 20 to the server 40 (Step S105).

Next, the server 40 generates control information for controlling the mobile body 200 based on the image and the like received from the information processing apparatus 10 (Step S106). Here, the server 40 may generate control information based on, for example, an input operation performed by a monitoring person (an operator) at a center that monitors the mobile body 200 based on the image. In this case, the control information may include, for example, a command for instructing the mobile body 200 that is driving autonomously by AI or the like to stop or resume its autonomous driving. Further, the control information may include information about remote control operations (e.g., operations of a brake, an accelerator, a steering wheel, etc.) performed by a monitoring person (an operator) at the center. Further, the server 40 may generate control information based on, for example, a result of inference performed by AI or the like that makes the mobile body 200 autonomously drive using an image.

Next, the server 40 transmits the generated control information to the information processing apparatus 10 (Step S107). Next, the control unit 15 of the information processing apparatus 10 controls the mobile body 200 based on the received control information (Step S108). Here, the control unit 15 controls each of the functions (e.g., the functions related to braking, propulsion, driving, steering, and the like) of the mobile body 200 based on the control information received from the server 40.

### Modified Example

Each functional unit of the information processing apparatus 10 may be implemented, for example, by cloud computing composed of one or more computers. Further, at least some of processes performed by the information processing apparatus 10 may be performed by at least one of the image capturing apparatus 20 and the server 40. The above-described information processing apparatus 10 is also included in an example of the “information processing apparatus” according to the present disclosure.

Note that the present invention is not limited to the above-described example embodiments and may be changed as appropriate without departing from the scope and spirit of the present invention.

The whole or part of the example embodiments disclosed above can be described as, but not limited to, the following supplementary notes.

### Supplementary Note 1

An information processing apparatus comprising:
acquisition means for acquiring information indicating a state of at least one of a person riding in a mobile body and an object mounted on the mobile body; and
specification means for specifying radio communication means used for communication between the mobile body and an external apparatus based on the information acquired by the acquisition means.

### Supplementary Note 2

The information processing apparatus according to supplementary note 1, wherein the specification means specifies the radio communication means used for communication in which the external apparatus performs at least one of monitoring of the mobile body and control of the mobile body.

### Supplementary Note 3

The information processing apparatus according to supplementary note 1 or 2, wherein the acquisition means acquires an image captured by an image capturing apparatus mounted on the mobile body.

### Supplementary note 4

The information processing apparatus according to any one of supplementary notes 1 to 3, wherein the acquisition means acquires an image of a route along which the mobile body moves captured by an image capturing apparatus installed in such a manner that it is able to capture the image.

### Supplementary Note 5

The information processing apparatus according to any one of supplementary notes 1 to 4, wherein
the information processing apparatus further comprises determination means for determining the state of at least one of the person riding in the mobile body and the object mounted on the mobile body based on the image acquired by the acquisition means, and
the specification means specifies the radio communication means based on information determined by the determination means.

### Supplementary Note 6

The information processing apparatus according to supplementary note 5, wherein the determination means determines at least one of the number of persons riding in the mobile body, an attribute of the person, a posture of the person, and a device used by the person based on the image acquired by the acquisition means.

### Supplementary Note 7

The information processing apparatus according to supplementary note 5 or 6, wherein the determination means determines at least one of the number of objects mounted on the mobile body, a weight of the object, a size of the object, a shape of the object, a value of the object, and a degree of shaking of the object.

### Supplementary Note 8

The information processing apparatus according to any one of supplementary notes 1 to 7, wherein the specification means calculates a degree of stability of the mobile body based on the information indicating the state of at least one of the person riding in the mobile body and the object mounted on the mobile body, and specifies the radio communication means based on the calculated degree of stability.

### Supplementary Note 9

The information processing apparatus according to any one of supplementary notes 1 to 8, wherein the specification means specifies a radio network used for the communication between the mobile body and the external apparatus among a plurality of radio networks based on the information acquired by the acquisition means.

### Supplementary Note 10

The information processing apparatus according to any one of supplementary notes 1 to 9, wherein the specification means specifies a virtual network used for the communication between the mobile body and the external apparatus among a plurality of virtual networks based on the information acquired by the acquisition means.

### Supplementary note 11

An information processing method comprising:
acquiring information indicating a state of at least one of a person riding in a mobile body and an object mounted on the mobile body; and
specifying radio communication means used for communication between the mobile body and an external apparatus based on the acquired information.

### Supplementary Note 12

A non-transitory computer readable medium storing a program for causing a computer to:
acquire information indicating a state of at least one of a person riding in a mobile body and an object mounted on the mobile body; and
specify radio communication means used for communication between the mobile body and an external apparatus based on the acquired information.

### Reference Signs List

1 INFORMATION PROCESSING SYSTEM
10 INFORMATION PROCESSING APPARATUS
11 ACQUISITION UNIT
12 SPECIFICATION UNIT
13 DETERMINATION UNIT
14 COMMUNICATION UNIT
15 CONTROL UNIT
20 IMAGE CAPTURING APPARATUS
30 IMAGE CAPTURING APPARATUS
40 SERVER

What is claimed is:

1. An information processing apparatus comprising:
at least one memory storing instructions, and
at least one processor configured to execute the instructions to;
acquire information indicating a state of at least one of a person riding in a mobile body and an object mounted on the mobile body; and
specify radio communication means used for communication between the mobile body and an external apparatus based on the acquired information.

2. The information processing apparatus according to claim 1, wherein the at least one processor is configured to specify the radio communication means used for communication in which the external apparatus performs at least one of monitoring of the mobile body and control of the mobile body.

3. The information processing apparatus according to claim 1, wherein the at least one processor is configured to acquire an image captured by an image capturing apparatus mounted on the mobile body.

4. The information processing apparatus according to claim 1, wherein the at least one processor is configured to acquire an image of a route along which the mobile body moves captured by an image capturing apparatus installed in such a manner that it is able to capture the image.

5. The information processing apparatus according to claim 1, wherein
the at least one processor is further configured to determining determine a state of at least one of the person riding in the mobile body and the object mounted on the mobile body based on the acquired image, and
the at least one processor is configured to specify the radio communication means based on the determined state.

6. The information processing apparatus according to claim 5, wherein the at least one processor is configured to determine at least one of the number of persons riding in the mobile body, an attribute of the person, a posture of the person, and a device used by the person based on the acquired image.

7. The information processing apparatus according to claim 5, wherein the at least one processor is configured to determine at least one of the number of objects mounted on the mobile body, a weight of the object, a size of the object, a shape of the object, a value of the object, and a degree of shaking of the object.

8. The information processing apparatus according to claim 1, wherein the at least one processor is configured to calculate a degree of stability of the mobile body based on the information indicating the state of at least one of the person riding in the mobile body and the object mounted on the mobile body, and specifies the radio communication means based on the calculated degree of stability.

9. The information processing apparatus according to claim 1, wherein the at least one processor is configured to specify a radio network used for the communication between the mobile body and the external apparatus among a plurality of radio networks based on the acquired information.

10. The information processing apparatus according to claim 1, wherein the at least one processor is configured to specify a virtual network used for the communication between the mobile body and the external apparatus among a plurality of virtual networks based on the acquired information.

11. An information processing method comprising:
acquiring information indicating a state of at least one of a person riding in a mobile body and an object mounted on the mobile body; and
specifying radio communication means used for communication between the mobile body and an external apparatus based on the acquired information.

12. A non-transitory computer readable medium storing a program for causing a computer to:
acquire information indicating a state of at least one of a person riding in a mobile body and an object mounted on the mobile body; and
specify radio communication means used for communication between the mobile body and an external apparatus based on the acquired information.
